(19) United States
(12) Patent Application Publication
(10) Pub. No.: US 2013/0213316 A1
(43) Pub. Date: Aug. 22, 2013

(54) MULTILAYER PET TOY AND METHOD OF MAKING SAME

(71) Applicants: Wayne Zhang, NanJing (CN); Ryan Rutherford, Rutherford, NJ (US)

(72) Inventors: Wayne Zhang, NanJing (CN); Ryan Rutherford, Rutherford, NJ (US)

(73) Assignee: J.W. PET COMPANY, INC., Teterboro, NJ (US)

(21) Appl. No.: 13/400,259

(22) Filed: Feb. 20, 2012

(51) Int. Cl. A01K 29/00; B32B 37/24

(52) U.S. Cl. 119/707; 156/242

(57) ABSTRACT

A multilayer pet toy has an inner structure having an inner-structure resilient material; an outer structure joined to the inner structure, the outer structure having a first layer having a first sandwich structure, the first sandwich structure having an outer-structure resilient material and a non-resilient material. Therein, the inner structure resilient material includes a first rubber compound that has a percentage of 30% or less by weight of natural rubber and a remainder being filler. The outer-structure resilient material includes a second rubber compound that has a percentage of 44% or more by weight of natural rubber and a remainder being filler.

### BACKGROUND OF THE INVENTION

1. Field of the Invention

The present invention is directed to a pet toy having multiple layers and a method of making same.

2. Discussion of the Related Art

A successful pet toy must satisfy six general criteria (“general criteria”): (1) may not be injurious to a pet; (2) design attractiveness to a purchaser; (3) initial interest by the pet; (4) continued engagement by the pet; (5) durability when played with by a pet; and (6) price attractiveness to a purchaser.

Design attractiveness to a purchaser (“design attractiveness”) requires that the pet toy have an aesthetic appearance that make the stand out among shelves of pet toys in a retail location

Initial interest by the pet (“initial interest”) requires that upon first encountering the pet toy, the pet should show an interest in playing with the toy. This can be achieved by an appealing shape, interesting sound, insertion of a treat, or other means.

Initial interest does not guaranty that the pet will continue to engage the toy (“continued engagement”). Continued engagement requires that the toy presents sufficient interest, for example, by removing a treat hidden inside a pet toy, so that the pet will play with the toy even after having been exposed to it.

Durability requires that the pet toy resist damage or destruction for a prolonged period.

Price attractiveness to a purchaser (“price attractiveness”) requires that the selling price of the pet toy be properly positioned for the kind of pet toy that is being purchased. Since the retail price is typically multiples of the manufacturing costs, price attractiveness means that the cost of manufacture be appropriate for the toy. However, as each of the general criteria is met, the costs increase.

A tennis ball or a tennis ball style toy meets many, but not all, of the criteria. It uses a core that is made of inexpensive rubber on which inexpensive felt material is glued. While pets, especially dogs, show an initial interest and continue to engage with the toy, the felt has a tendency to cause wear on the teeth of the pet.

Tennis balls also do not last long with aggressively biting pets. Tennis balls are typically filled with pressurized air so that the ball has sufficient bounce for competitive sport play. Aggressive biters readily breach the core of a tennis ball rendering it limp and uninteresting for the pet.

From empirical observations, it is believed that purchasers find a tennis ball to be a purchase of last choice and is based simply on the minimal cost of a tennis ball or tennis ball style toy.

In contrast, an aesthetically pleasing rubber or vinyl pet toy has a higher likelihood of being purchased. These toys are designed to be safe for pets and pets generally show a great amount of interest in the toys when first introduced to them.

Vinyl toys are generally inexpensive, but not durable. Rubber toys tend to be durable based on the quality of rubber that is used, but the material costs also increase with an increase in rubber quality. Even when high quality rubber is used, limitations due to the manufacturing process may prevent a toy from being designed in such a way as to have continued engagement by the pet.

Thus, what is desired is a pet toy that satisfies all of the above criteria at an economical cost.

### SUMMARY OF THE INVENTION

These and other criteria are met by the present invention of a multilayer pet toy.

In accordance with one or more embodiments of the present invention, the multilayer pet toy has an inner structure having an inner-structure resilient material; an outer structure joined to the inner structure, the outer structure having a first layer having a first sandwich structure, the first sandwich structure having an outer-structure resilient material and a non-resilient material. Therein, the inner structure resilient material includes a first rubber compound that has a percentage of 30% or less by weight of natural rubber and a remainder being filler. The outer-structure resilient material includes a second rubber compound that has a percentage of 44% or more by weight of natural rubber and a remainder being filler.

In accordance with one or more embodiments of the present invention, the multilayer pet toy has an inner structure and an outer structure, a layer of adhesive joining the outer structure to the inner structure. The inner structure includes a vulcanized inner-structure resilient material; and the outer structure includes a first layer having a vulcanized outer-structure resilient material and a textured finish.

In accordance with one or more embodiments of the present invention, the inner structure resilient material consists of a first rubber compound that has a percentage of 30% by weight of natural rubber and a remainder being filler and the outer-structure resilient material consists of a second rubber compound that has a percentage of 44% by weight of natural rubber and a remainder being filler.

In accordance with one or more embodiments of the present invention, a method of making a multilayer pet toy, includes
(a) forming a first part and a second part of the inner structure by molding;
(b) joining the first and second parts by gluing;
(c) vulcanizing the joined first and second parts to form an inner structure;
(d) joining at least one segment of the first layer to the inner structure by gluing to form an intermediate structure; and
(e) vulcanizing the intermediate structure to form the multilayer pet toy.

In accordance with one or more embodiments of the present invention, a further method includes
(a) forming a first part and a second part of the inner structure by molding;
(b) joining the first and second parts by gluing;
(c) vulcanizing the joined first and second parts to form an inner structure;
(d) applying an adhesive layer to the inner structure and joining at least one segment of the first layer to the inner structure to form an intermediate structure; and
(e) vulcanizing the intermediate structure to form the multilayer pet toy.

### BRIEF DESCRIPTION OF THE DRAWINGS

FIG. 1a is an isometric view with a partial cut away of a multilayer pet toy in accordance with one or more embodiments of the present invention.

FIG. 1b is a cross-sectional view of the toy of FIG. 1a.

FIG. 1c is a detail view of a portion of FIG. 1a.

FIG. 2a is a side view of a multilayer pet toy in accordance with one or more embodiments of the present invention.

FIG. 2b is a longitudinal cross-sectional view of the toy of FIG. 2a.

FIGS. 2c and 2d are transverse cross-sectional views of the toy of FIG. 2a.

FIG. 2e is a longitudinal cross-sectional view of the toy of FIG. 2a showing a squeaker in accordance with one embodiment of the present invention.

FIG. 3a is a side view of a multilayer pet toy in accordance with one or more embodiments of the present invention.

FIG. 3b is a longitudinal cross-sectional view of the toy of FIG. 2a.

FIGS. 3c and 3d are transverse cross-sectional views of the toy of FIG. 2a.

FIG. 4 is a diagram illustrating a method of making a multilayer pet toy in accordance with one or more embodiments of the present invention.

### DETAILED DESCRIPTION OF THE INVENTION

In accordance with one or more embodiments of the present invention, a multilayer pet toy 10, 200, 300, or a combination thereof meets each of the general criteria and is made by a method 100 that allows multilayer pet toy to be industrially economical to produce.

Each toy comprises features that are non-injurious to animals, and in particular to animals that bite and chew, such as dogs. The non-injurious features may comprise one or more of the following or preferably all of the following: rounded corners, pliability, use of non-toxic materials, non-toxic manufacturing process, non-breaking materials and elements, non-flaking materials and elements.

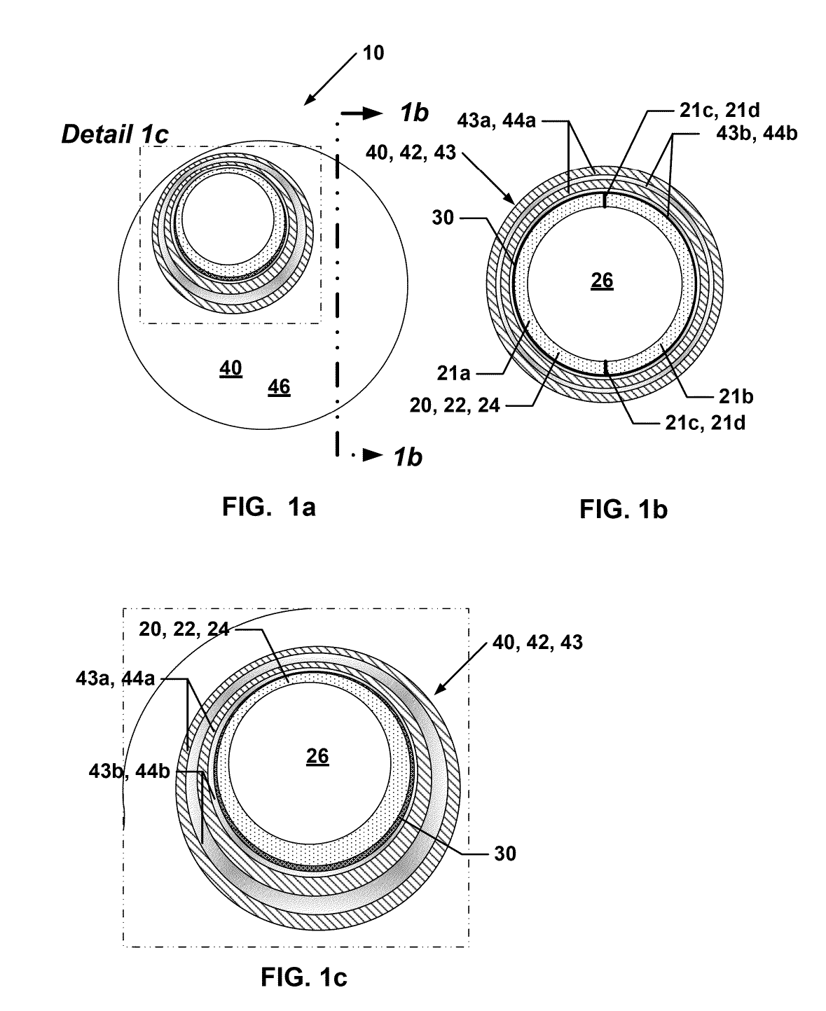

FIG. 1a is an isometric view with a partial cut away of a multilayer pet toy in accordance with one or more embodiments of the present invention. FIG. 1b is a cross-sectional view of the toy of FIG. 1a. FIG. 1c is a detail view of a portion of FIG. 1a.

Multilayer pet toy 10 may be used as a play toy for a child, but preferably is a pet toy for an animal, such as a dog, that has repeatedly bites the toy. Multilayer pet toy may have any shape, and is not limited to the ball depicted in the drawings, may or may not have a sound-making device of any sort, and/or may or may not have openings.

In accordance with one or more embodiments of the present invention, multilayer pet toy 10 comprises an inner structure 20 and an outer structure 40 joined to the inner structure.

Inner structure 20 comprises a resilient core comprising one or more inner parts 21, which may be halves such as parts 21a and 21b. The one part or more than one part may enclose an interior space 26. Inner structure 20 may have any suitable shape, such as a shape representative of animal, an object, an abstract geometric shape, or any combination thereof.

Each part 21 may be made of one or more layers 22 and each part 21 of inner structure 20 may have a different number of layers 22 than another part 21. However, preferably, all parts have the same number of layers 22, and in particular preference, have a single layer 22.

In turn, each layer 22 may comprise one or more resilient materials 24, i.e., an inner-structure resilient material, which may be one or more natural rubber compounds, one or more artificial rubber compounds, one or more rubber-related polymers, and/or a thermoplastic and/or elastomeric material. Each of these may be foamed or unfoamed.

However, advantageously one or more inner layers 22 are preferably made of resilient material 24 that comprises one or more unfoamed rubber compounds with a low percentage of pure natural rubber. Therein, preferably resilient material 24 comprises of a rubber compound that has a percentage of no more 30% by weight of natural rubber and the remainder comprising fillers, or resilient material 24 consists of a rubber compound that has a percentage having 30% by weight of natural rubber and 70% by weight consisting of fillers. All or each of the one or more inner layers 22, preferably, have a uniform cross-sectional width of 3.5-5 mm, wherein 5 mm is preferred.

Most preferably, inner structure 20 consists of a single inner layer 22, because it provides a suitable amount of rigidity, but also is economical.

In one or more embodiments, space 26 may be in fluid communication with the ambient air outside of multilayer pet toy 10 via a sound-making device such as a squeaker, a sliding noisemaker through which air passes, or an electronic noisemaker to arouse initial interest and continued engagement by the animal. In accordance with one or more embodiments of the present invention, toy 10 does not have an interior space 26.

In accordance with one or more embodiments of the present invention, space 26 may be used to house treats and, thus, has an access to insert and remove treats. In order to increase the challenge of removing the treat, space 26 and multilayer pet toy 10 may include one or more baffles as taught in U.S. Pat. No. 7,866,281, which is hereby incorporated by reference in its entirety for all purposes.

In accordance with one or more embodiments of the present invention, space 26 may be filled preferably with air at ambient pressure at the time manufacture, but could also be filled with a gas, such as argon, nitrogen, or the like, at ambient pressure or have a vacuum. Each has unique and distinctive advantages and disadvantages, but the advantages of using air at ambient pressure at the time manufacture are the lack of costs, lack of adverse chemical interaction, and manufacturing simplicity.

Exterior structure 40 comprises one or more outer layers 42. The outermost layer 42 preferably comprises one or more textures 46, that have a high design attractiveness. Each layer 42 may comprise one or more sandwich structures 43, where each sandwich structure 43 comprises or consists of a resilient material layer 43a and a non-resilient material layer 43b.

Resilient material layer 43a may comprise one or more resilient materials 44a, i.e., an outer-structure resilient material, which may be one or more natural rubber compounds, one or more artificial rubber compounds, one or more rubber-related polymers, and/or a thermoplastic and/or elastomeric material. Preferably, resilient material 44a comprises one or more rubber compounds having a high percentage of natural rubber. Therein, resilient material 44a most preferably comprises at least 44% by weight of natural rubber and the remainder by weight comprising fillers or resilient material 44a consists of 44% by weight of natural rubber and the remainder by weight consisting.

The difference in the percentage of rubber compound permits use of a more inexpensive material in the interior and a more expensive, and appealing, material on the outside for toy 10, as well as toys 200 and 300, described below. This provides the distinct advantages of design attractiveness and price attractiveness.

Non-resilient material layer 43b may comprise one or more materials 44b that are substantially less resilient than the one or more materials 44a. Material 44b may comprise paper, woven textiles, non-woven textile, fleece, and/or any other suitable material. That is, while material 44b has resilience, its reliance is substantially less than the resilience of material 44a. Therein, material 44b has a modulus of resilience that is 15% or less of the modulus of resilience of material 44a. In the alternative, material 44b has a Young's modulus, i.e., tensile modulus, that is 15% or less of a Young's modulus of material 44a.

All or each of the one or more outer layers 42 preferably have a uniform cross-sectional width of 0.8 to 1.5 mm.

Most preferably, inner structure 20 consists of a single outer layer 42 having a single sandwich structure 43 having a single resilient material layer 43a and a single non-resilient material layer 43b, because it is economical, but also durable.

An adhesive layer 30 is disposed between all or a portion of inner structure 20 and all or a portion of a first layer 42 of outer structure 40 and serves to join the first layer of the outer structure to the inner structure. Therein, adhesive layer 30 comprises any suitable adhesive, but preferably comprises or consists of a rubber cement.

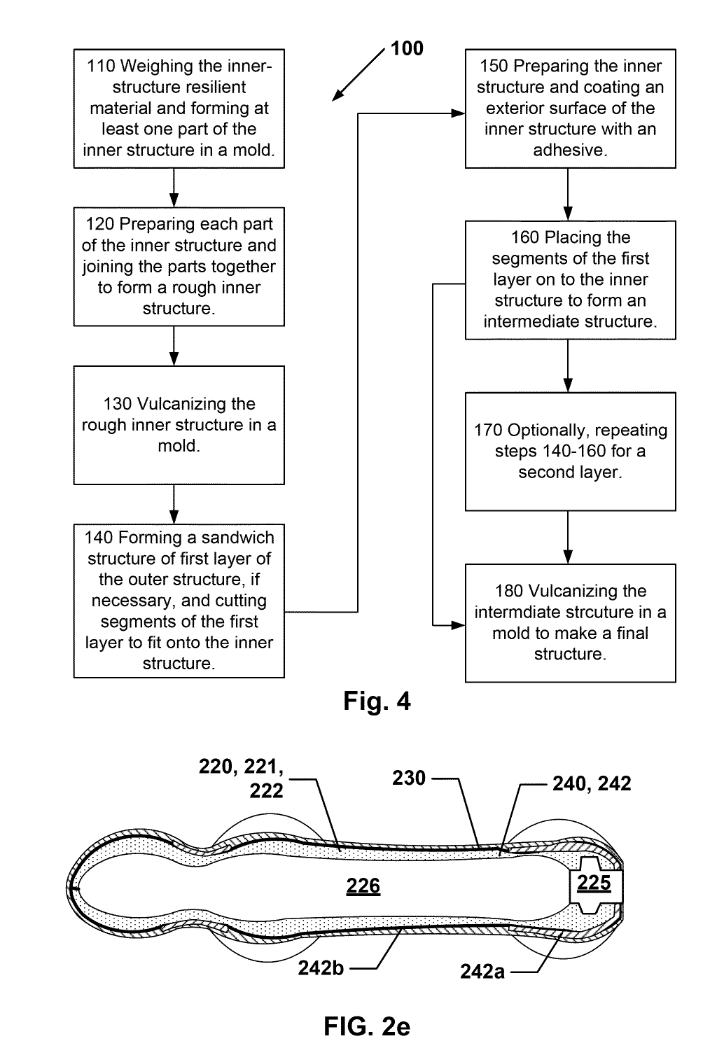

FIG. 4 is a diagram illustrating a method of making a multilayer pet toy in accordance with one or more embodiments of the present invention. Multilayer pet toy 10 is preferably made by method 100.

Therein prior to any steps, all materials are provided. In a first step 110, one or more portions of resilient material 24 are removed from a larger batch of resilient material to form one or more portions of raw material for parts 21. By weighing or in some other way determining the proper amount, the one or more portions of resilient material 24 are sized such that they are suitable to form one or more parts 21.

Then, each of the correctly sized one or more portions of resilient material 24 are placed in a respective mold, or the same mold is used sequentially, and one or more rough parts 21 are formed by vulcanization, as is known in the art.

“Rough” herein means that the item or items are not finished may have unfinished edges, tags, or other imperfections, that will be corrected, by for example, trimming or sanding the item before the “rough” item is used in a subsequent step or that another process step is required to form a “finished” item that is part of the toy.

In a step 120, if more than one part 21 is necessary for toy 10, each part 21 is prepared so that it can be joined to another part 21, as needed for the particular shape of toy 10.

Preparation may require that portions of parts 21 are roughened, by for example, sanding or by coating with one or more chemical agents to make adhesion to another part 21. If more than one part 21 is necessary for toy 10, parts 21 joined together by use of an adhesive and/or a setting agent and proper alignment to form a rough inner structure 20.

Thus, in the illustrated embodiment of FIGS. 1a-1c, parts 21a and 21b are joined along circumferential edges 21c and 21d, respectively, the circumferential edges may be prepared by sanding on a sand paper having a suitable grit, such as grit number 120. Then, circumferential edges 21c and 21d, respectively, are joined by gluing and proper alignment to form the inner structure.

In a step 130, rough inner structure 20 is placed in a mold is vulcanized to add strength to the inner structure. Preferably, vulcanization is carried out in a range from 0 to 160 degree centigrade.

In a step 140, preferably resilient material layer 43a and, if needed, non-resilient material layer 43b are provided joined together as sheets of sandwich structure 43, which are then cut into segments that in the finished toy will be layers 42. If resilient material layer 43a and non-resilient material layer 43b are provided separately, preliminary to step 170, the layers 43a and 43b are joined together, as for example, by gluing or heat adhesion.

In order to fit onto inner structure 20 and form layers 42, the segments may have to be cut into particular shapes. In the illustrated embodiment of FIGS. 1a-1c, the segments are preferably cut into dumbbell shapes so that two segments can be joined together perpendicularly to each other, as for example, example is known with respect to placing felt material on a tennis ball.

In a step 150, all or a portion of an exterior surface of inner structure 20 is optionally roughened, such as by sanding and then all or a portion of an exterior surface of inner structure 20 is coated with an adhesive to form adhesive layer 30.

In a step 160, the cut segments are then placed on inner structure 20 to form an intermediate structure. Thus, in the illustrated embodiment of FIGS. 1a-1c, the segments are preferably joined together perpendicularly to each other.

In an optional step 170, when multiple layers 42 are desired, steps 150 to 160 are repeated. Therein, however, the adhesive is added to an exterior surface of the first layer of layer 42 so that a further layer 42 can be joined to form the intermediate structure.

In a step 180, the intermediate structure is then placed in a mold having the one or more textures 46 on an inside surface of the mold cavity and, if necessary, is air is pumped into inner space 26 to force the toy against the inside surface via an air hole provided through inner structure 20. The intermediate structure is then vulcanized to form toy 10. After vulcanization ends, the mold is opened and toy 10 is removed.

In subsequent steps, a noise maker may be inserted in the air hole.

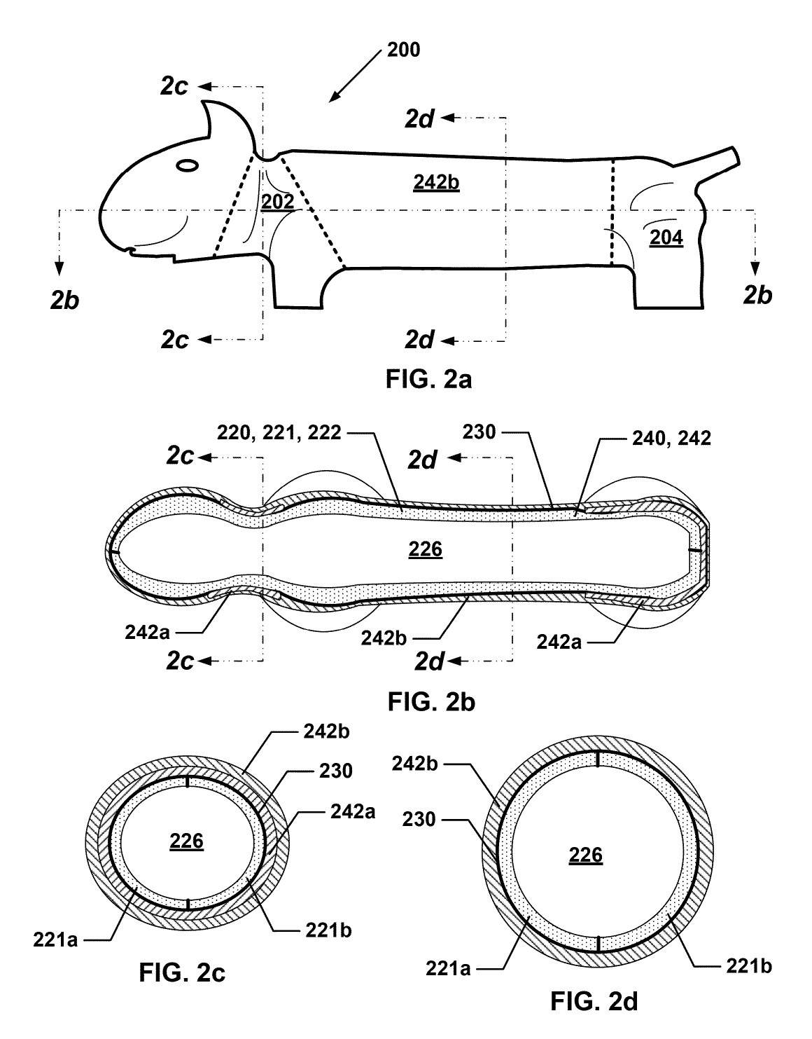

FIG. 2a is a side view of a multilayer pet toy in accordance with one or more embodiments of the present invention. FIG. 2b is a longitudinal cross-sectional view of the toy of FIG. 2a. FIGS. 2c and 2d are transverse cross-sectional views of the toy of FIG. 2a.

Therein, a multilayer pet toy 200 may be used as a play toy for a child, but preferably is a pet toy for an animal, such as a dog, that has repeatedly bites the toy and is made generally by method 100, except as modified herein.

In accordance with one or more embodiments of the present invention, multilayer pet toy 200 comprises an inner structure 220 and an outer structure 240. An adhesive layer 230 is disposed between all or a portion of inner structure 220 and all or a portion of a first layer of outer structure 240 and serves to join the first layer of the outer structure to the inner structure. Therein, adhesive layer 230 preferably comprises a material substantially identical to the adhesive of adhesive layer 30.

Inner structure 220 comprises a resilient core comprising one or more inner parts 221, which may be halves such as parts 221a and 221b. The one part or more than one part may enclose an interior space 226. Inner structure 220 may have any suitable shape, such as a shape representative of animal, an object, an abstract geometric shape, or any combination thereof.

Each part 221 may be made of one or more layers 222 and each part 221 of inner structure 220 may have a different number of layers 222 than another part 221. However, preferably, all parts have the same number of layers 222, and in particular preference, have a single layer 222. In turn, each layer 222 may comprise one or more resilient materials 24, as taught above.

FIG. 2e is a longitudinal cross-sectional view of the toy of FIG. 2a showing a squeaker in accordance with one embodiment of the present invention. Space 226 may be in fluid communication with the ambient air outside of multilayer pet toy 200 via a sound-making device such as a squeaker 225. Instead of squeaker 225, a sliding noisemaker through which air passes, an electronic noisemaker, or other noisemaker may be used.

In accordance with one or more embodiments of the present invention, space 226 may be used to house treats and, thus, has an access to insert and remove treats, as taught with respect to space 26 and/or incorporate any other feature taught with respect to space 26.

Exterior structure 240 comprises one or more outer layers 242. The outermost layer 242 preferably comprises one or more textures, such as textures 46, that has a high design attractiveness. Each layer 242 may comprise one or more sandwich structures, such as those taught with respect to structures 43 and not shown in FIGS. 2b-2d for simplicity, where each sandwich structure comprises or consists of a resilient material layer, substantially similar to layer 43a and a non-resilient material layer, substantially similar to layer 43b.

The resilient material layer of multilayer pet toy 200 may comprise one or more resilient materials, which preferably are substantially similar as taught with respect to resilient material 44a. The non-resilient material layer may comprise one or more non-resilient materials, which preferably are substantially similar to non-resilient material 44b.

All or each of the one or more outer layer 242 have similar properties and dimensions as taught with respect to layers 42.

Toy 200 is configured to have areas, such as neck area 202, that are unintentionally thinned during molding and vulcanization as the material in that region becomes stretched by the mold shape. This would cause the toy to fail at area 202.

By empirical study, toy 200 includes areas, such as rear area 204, which are more often chewed than other areas. This leads to frequent failure of the toy.

Thus, preferably, toy 200 includes a reinforcing layer 242a in areas 202 and 204.

To make toy 200, steps 110-160 are performed as taught above. In step 170, reinforcing layers 242a are glued on to inner structure 220 in areas 202 and 204. Then, glue is added to an exterior surface of layer 242a so that a further layer 242b can be joined to form the intermediate structure. The further layer 242b is then secured and step 180 is then performed.

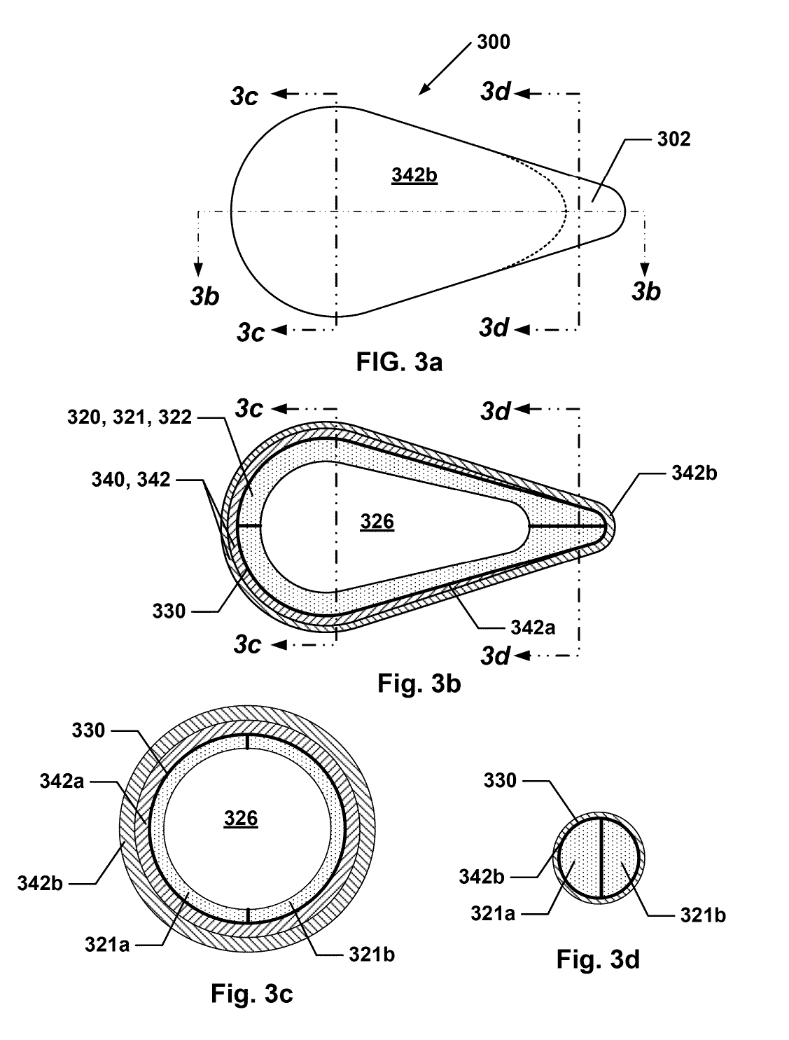

FIG. 3a is a side view of a multilayer pet toy in accordance with one or more embodiments of the present invention. FIG. 3b is a longitudinal cross-sectional view of the toy of FIG. 2a. FIGS. 3c and 3d are transverse cross-sectional views of the toy of FIG. 2a.

Therein, a multilayer pet toy 300 may be used as a play toy for a child, but preferably is a pet toy for an animal, such as a dog, that has repeatedly bites the toy and is made generally by method 100, except as modified herein.

In accordance with one or more embodiments of the present invention, multilayer pet toy 200 comprises an inner structure 320 and an outer structure 340. An adhesive layer 330 is disposed between all or a portion of inner structure 320 and all or a portion of a first layer of outer structure 340 and serves to join the first layer of the outer structure to the inner structure. Therein, adhesive layer 330 preferably comprises a material substantially identical to the adhesive of adhesive layer 30.

Inner structure 320 comprises a resilient core comprising one or more inner parts 321, which may be halves such as parts 321a and 321b. The one part or more than one part may enclose an interior space 326. Inner structure 320 may have any suitable shape, such as a shape representative of animal, an object, an abstract geometric shape, or any combination thereof.

Each part 321 may be made of one or more layers 322 and each part 321 of inner structure 320 may have a different number of layers 322 than another part 321. However, preferably, all parts have the same number of layers 322, and in particular preference, have a single layer 322. In turn, each layer 322 may comprise one or more resilient materials 24, as taught above.

In one or more embodiments, space 326 may be in fluid communication with the ambient air outside of multilayer pet toy 300 via a sound-making device such as a squeaker, a sliding noisemaker through which air passes, or an electronic noisemaker.

In accordance with one or more embodiments of the present invention, space 326 may be used to house treats and, thus, has an access to insert and remove treats, as taught with respect to space 26 and/or incorporate any other feature taught with respect to space 26.

Exterior structure 340 comprises one or more outer layers 342. The outermost layer 342 preferably comprises one or more textured finishes, such as textures 46, that has a high design attractiveness. Each layer 342 may comprise one or more sandwich structures, such as those taught with respect to structures 43 and not shown in FIGS. 3b-3d for simplicity, where each sandwich structure comprises or consists of a resilient material layer, substantially similar to layer 43a and a non-resilient material layer, substantially similar to layer 43b.

The resilient material layer of multilayer pet toy 300 may comprise one or more resilient materials, which preferably are substantially similar as taught with respect to resilient material 44a. The non-resilient material layer may comprise one or more non-resilient materials, which preferably are substantially similar to non-resilient material 44b.

All or each of the one or more outer layer 342 have similar properties and dimensions as taught with respect to layers 42.

Toy 300 is configured to have areas, such as weighted tip area 302 that includes a solid portion of inner structure 320. By weighting the tip, toy 300 becomes more playable since the weighting adds a random factor when toy 300 is thrown. However, by being solid in cross-section in area 302, toy 300 can be made more cost efficient by omitting a second outer layer 342. Thus, preferably, toy 300 includes two layers 342 in all areas except the tip area 302.

To make toy 300, steps 110-160 are performed as taught above. In step 170, a first layer 342a is glued on to inner structure 320 in areas other than area 302. Then, glue is added to an exterior surface of layer 342a and in area 302 so that a further layer 342b can be joined to form the intermediate structure. The further layer 342b is then secured and step 180 is then performed.

While the invention has been described in conjunction with specific embodiments, it is to be understood that many alternatives, modifications, and variations will be apparent to those skilled in the art in light of the foregoing description.

What is claimed is:

1. A multilayer pet toy comprising:
an inner structure and an outer structure;
a layer of adhesive joining the outer structure to the inner structure;
the inner structure comprising an inner-structure resilient material; and
the outer structure comprising a first layer having an outer-structure resilient material.

2. The multilayer pet toy of claim 1, wherein the inner structure resilient material comprises a first vulcanized material and the outer structure resilient material comprises a second vulcanized material.

3. The multilayer pet toy of claim 1, wherein the inner structure resilient material comprises a first rubber compound that has a percentage of 30% or less by weight of natural rubber and a remainder being filler.

4. The multilayer pet toy of claim 3, wherein the outer-structure resilient material comprises a second rubber compound that has a percentage of 44% or more by weight of natural rubber and a remainder being filler.

5. The multilayer pet toy of claim 1, wherein the inner structure resilient material consists of a first rubber compound that has a percentage of 30% by weight of natural rubber and a remainder being filler.

6. The multilayer pet toy of claim 5, wherein the outer-structure resilient material consists of a second rubber compound that has a percentage of 44% by weight of natural rubber and a remainder being filler.

7. The multilayer pet toy of claim 1, wherein the non-resilient material comprises a textile.

8. The multilayer pet toy of claim 1, wherein the outer structure comprises a first sandwich structure, the first sandwich structure comprising the outer layer resilient material and a non-resilient material.

9. The multilayer pet toy of claim 8, wherein the inner structure comprises a first part and a second part, the two parts being separately molded.

10. The multilayer pet toy of claim 1, further comprising a squeaker.

11. A method of making a multilayer pet toy, the multi layer pet toy comprising
an inner structure and an outer structure;
a layer of adhesive joining the outer structure to the inner structure;
the inner structure comprising an inner-structure resilient material; and
the outer structure comprising a first layer having an outer-structure resilient material;
the method comprising
(a) forming a first part and a second part of the inner structure by molding;
(b) joining the first and second parts by gluing;
(c) applying an adhesive layer to the inner structure and joining at least one segment of the first layer to the inner structure to form an outer structure.

12. The method of claim 11, wherein after step (b), a step of vulcanizing the joined first and second parts to form an inner structure is performed.

13. The method of claim 12, wherein after step (c), a step vulcanizing the outer structure to form the multilayer pet toy is performed.

14. The method of claim 11, wherein step (c) further comprises applying an adhesive layer joining at least one segment of a second layer to form an outer structure.

15. The method of claim 11, wherein step (b) is performed along a peripheral edge of each of the parts.

16. The method of claim 11, wherein the inner structure resilient material comprises a first rubber compound that has a percentage of 30% or less by weight of natural rubber and a remainder being filler.

17. The method of claim 16, wherein the outer-structure resilient material comprises a second rubber compound that has a percentage of 44% or more by weight of natural rubber and a remainder being filler.

18. The method of claim 11, wherein the inner structure resilient material consists of a first rubber compound that has a percentage of 30% by weight of natural rubber and a remainder being filler.

19. The method of claim 18, wherein the outer-structure resilient material consists of a second rubber compound that has a percentage of 44% by weight of natural rubber and a remainder being filler.

20. The method of claim 11, wherein vulcanization is performed at a temperature no greater than 160 degrees centigrade.
